(19) United States
(12) Patent Application Publication
(10) Pub. No.: US 2024/0418940 A1
(43) Pub. Date: Dec. 19, 2024

(54) OPTICAL CONNECTOR WITH FULCRUM FOR OPTICAL ALIGNMENT

(71) Applicant: 3M INNOVATIVE PROPERTIES COMPANY, St. Paul, MN (US)

(72) Inventor: Michael A. Haase, St. Paul, MN (US)

(21) Appl. No.: 18/705,015

(22) PCT Filed: Oct. 5, 2022
(86) PCT No.: PCT/IB2022/059514

§ 371 Date: Apr. 26, 2024

Related U.S. Application Data
(60) Provisional application No. 63/273,432, filed on Oct. 29, 2021.

(51) Int. Cl. G02B 6/30; G02B 6/34

(52) U.S. Cl. CPC G02B 6/30; G02B 6/34

(57) ABSTRACT

An optical cradle is configured to mate with an optical ferrule and permanently bond to a substrate so that light from an optical waveguide coupled to the optical ferrule exits the optical ferrule and couples to an optical component on the substrate after entering the optical cradle at a first location of the optical cradle. The optical cradle includes at least one fulcrum extending from a bottom surface of the optical cradle and configured to make contact with the substrate and allow a rotation of the optical cradle about the contact to angularly align the optical cradle to the optical component without substantially changing a distance, d, between the first location and the optical component.

### SUMMARY

In some aspects of the present description, an optical cradle is provided, the optical cradle configured to mate with an optical ferrule and permanently bond to a substrate so that light may be coupled between an optical waveguide coupled to the optical ferrule and an optical component through at least a first location of the optical cradle. The optical cradle includes at least one fulcrum extending from a bottom surface of the optical cradle and configured to make contact with the substrate and to allow a rotation of the optical cradle about the contact to angularly align the optical cradle to the optical component without substantially changing a distance, d, between the first location and the optical component.

In some aspects of the present description, an optical cradle is provided, the optical cradle configured to removably receive and secure an optical ferrule so that a central light ray exiting the optical ferrule enters the optical cradle at a first location of the optical cradle and exits the optical cradle at a second location of the optical cradle. The first and second locations define an optical axis passing therethrough. The optical cradle includes one or more pivot portions extending from a bottom surface of the optical cradle and defining an axis of rotation of the optical cradle, such that the optical axis passes within about 500 microns of the axis of rotation.

In some aspects of the present description, an optical cradle is provided, the optical cradle configured to mount on a substrate and receive and secure an optical ferrule so that a central light ray is coupled between the optical ferrule and an optical component of the substrate. The optical cradle includes one or more pivot portions extending from a bottom surface of the optical cradle and defining, in combination, an axis of rotation of the optical cradle, such that when the optical cradle rests on the substrate, the one or more pivot portions allow the optical cradle to rotate about the axis of rotation to adjust a tilt of the optical cradle relative to the substrate.

In some aspects of the present description, an optical cradle is provided, the optical cradle including a fulcrum extending from a bottom surface of the optical cradle and configured to mount on a substrate and receive and secure an optical ferrule. When the optical cradle is mounted, and the fulcrum rests on the substrate, the optical cradle is configured to rock by at least about 0.5 degrees about the fulcrum to optimize a coupling of light from an optical waveguide attached to the optical ferrule to an intended optical component of the substrate.

In some aspects of the present description, an optical cradle is provided, the optical cradle configured to mount on a substrate and receive and secure an optical ferrule. When the optical cradle is permanently mounted on the substrate and light from the optical ferrule is optimally transmitted to an optical component of the substrate, the optical cradle makes physical contact with the substrate only along one or more substantially colinear lines of contact.

In some aspects of the present description, a method of aligning an optical cradle to an optical component is provided, the method including the steps of inserting an optical ferrule in the optical cradle, the optical cradle including a pocket for receiving and securing the optical ferrule and at least one fulcrum configured to make contact with the substrate, bringing the fulcrum into contact with the substrate, while coupling light between the optical ferrule and the optical component, aligning the cradle with the optical component, wherein aligning the cradle with the optical component includes the steps of measuring a strength of the light coupled between the optical ferrule and the optical component, and rotating the optical cradle about the fulcrum to angularly align the optical cradle to the optical component based on the strength of the coupled light, applying an adhesive to the optical cradle, and curing the adhesive.

### BRIEF DESCRIPTION OF THE DRAWINGS

FIG. 1 is a perspective view of an optical cradle with a fulcrum feature, in accordance with an embodiment of the present description;

FIG. 2 is an alternate perspective view of an optical cradle with a fulcrum feature, in accordance with an embodiment of the present description;

FIG. 3 is an additional alternate perspective view of an optical cradle with a fulcrum feature, in accordance with an embodiment of the present description;

FIG. 4 is a cutaway view of an optical connection between an optical ferrule and an optical cradle, in accordance with an embodiment of the present description;

FIG. 5 is a cutaway view of an optical cradle with a fulcrum feature, showing additional details of the optical path, in accordance with an embodiment of the present description; and

FIG. 6 is a flowchart detailing the steps in a method of aligning an optical cradle to an optical component, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

As data rates in computers continue to rise, copper conductors become increasingly unable to transport large amounts of highspeed data between components at the speeds the customers demand. Silicon photonics (i.e., systems which use silicon as an optical medium to transport data) helps ease this bottleneck by enabling data transport through optical fiber rather than copper traces. The efficient coupling of light between optical fibers and small-core photonic integrated circuit (PIC) waveguides can be challenging to achieve. Existing solutions involve active alignment and permanent attachment of the optical fibers which is expensive, slow, often high loss, and incompatible with the temperatures associated with solder reflow of the PIC.

Some silicon photonics systems have used a pluggable connector interface between the optical fibers and silicon photonics transceivers, including an optical cradle which is bonded to the PIC and an optical ferrule that is seated into the optical cradle and held in optical alignment with the transceiver. While this pluggable interface provides an improvement in the process of obtaining optical alignment, it can still be challenging to align the lenses built into some optical cradles to the optical grating couplers on the PIC. The cradle lenses must be aligned laterally with their respective grating couplers for optical data transfer. However, fabrication process variations can result in significant cross-wafer and wafer-to-wafer variations in the angle of the output beams from the grating couplers, so the cradle must be actively angularly aligned to focus light into (or out of) the grating couplers, while holding the grating couplers at or near the focal point of the respective cradle lenses.

According to some aspects of the present description, an optical cradle includes a fulcrum feature that extends from the bottom of the optical connector (e.g., from the bottom of an optical cradle) which allows the optical connector to be tilted to adjust the alignment of the optical cradle lens with an optical component (e.g., the grating couplers of a PIC). In some embodiments, the optical cradle may be configured to mate with an optical ferrule and permanently bond to a substrate so that light may be coupled between an optical waveguide (e.g., an optical fiber) coupled to the optical ferrule and an optical substrate through at least a first location of the optical cradle. In some embodiments, the optical cradle may include at least one fulcrum configured to make contact with the substrate and to allow a rotation of the optical cradle about the contact to angularly align the optical cradle to the optical component without substantially changing a distance, d, between the first location and the optical component.

In some embodiments, the optical cradle further includes an optical lens disposed proximate the first location. In some embodiments, the distance between the first location and the optical component is approximately equal to the focal length of the optical lens.

In some embodiments, the at least one fulcrum may include at least two segments separated by a space. In some embodiments, the space may be such that the at least two segments are disposed on opposing sides of the optical component and the at least one fulcrum does not directly contact the optical component. Stated another way, the segments of the fulcrum (e.g., the pivot points of the fulcrum which are in contact with the substrate) may be spaced such that they straddle the optical component (e.g., grating couplers of a PIC) to which the cradle is being aligned (to avoid damaging the optical component during active alignment.)

According to some aspects of the present description, an optical cradle may be configured to removably receive and secure an optical ferrule (e.g., the cradle may include a “pocket” configured to receive the optical ferrule and hold it in alignment to an optical component) so that a light ray exiting the optical ferrule enters the optical cradle at a first location of the optical cradle and exits the optical cradle at a second location of the optical cradle. The first and second locations may define an optical axis passing therethrough. In some embodiments, the optical cradle may include one or more pivot portions (e.g., one or more fulcrum segments) defining an axis of rotation of the optical cradle that passes through or near the axis of rotation. In some embodiments, the optical axis may pass within about 500 microns, or about 450 microns, or about 400 microns, or about 350 microns, or about 300 microns, or about 250 microns, or about 200 microns, or about 150 microns, or about 100 microns, or about 50 microns, or about 25 microns, or about 10 microns, or about 5 microns of the axis of rotation.

In some embodiments, the optical cradle may further include an optical lens at at least one of the first and second locations. In some embodiments, the optical lens may be configured to change an optical property of the light passing therethrough, such as a divergence of the light (e.g., to cause the light to be focused to a location).

In some embodiments, the optical component may be within about 50 microns (or about 45 microns, or about 40 microns, or about 35 microns, or about 30 microns, or about 25 microns, or about 20 microns, or about 15 microns, or about 10 microns, or about 5 microns of a focal point of the optical lens.

In some embodiments, the one or more pivot portions of the optical cradle may be disposed such that they do not include the second location of the optical cradle (e.g., the pivot portions may be disposed on one or more sides of the second location, such as two pivot portions on opposing sides of the second location, so as not to interfere with the coupling of light from the second location).

According to some aspects of the present description, an optical cradle may be configured to mount on a substrate and to receive and secure an optical ferrule so that a central light ray is coupled between the optical ferrule and an optical component (e.g., a grating coupler of a photonics integrated circuit) of the substrate. That is, the optical cradle may be configured to hold the optical ferrule in alignment with the optical component. In some embodiments, the optical cradle may include one or more pivot portions defining, in combination, an axis of rotation of the optical cradle. In some embodiments, when the optical cradle rests on the substrate, the one or more pivot portions may allow the optical cradle to rotate about the axis of rotation to adjust a tilt of the optical cradle relative to the substrate.

In some embodiments, the one or more pivot portions may be configured such that the tilt of the optical cradle relative to the substrate may be adjusted by up to 5 degrees, or up to 2 degrees, or up to 1.5 degrees, or up to 1.0 degree, or up to 0.5 degrees. In some embodiments, rotating the optical cradle about the axis of rotation may change an angle of an optical path of the light ray between the optical ferrule and the optical component. In some embodiments, the optical component may include an optical grating coupler. In some embodiments, changing the angle of the optical path of the light ray between the optical ferrule and the optical component changes a strength of an optical signal (i.e., light ray) coupled between an optical waveguide (e.g., optical fiber) coupled to the optical ferrule and the optical component.

According to some aspects of the present description, an optical cradle may include a fulcrum and may be configured to mount on a substrate and receive and secure an optical ferrule. In some embodiments, when the optical cradle is mounted, and the fulcrum rests on the substrate, the optical cradle may be configured to rock by at least about 0.5 degrees, or about 1.0 degree, or about 1.5 degrees, or about 2 degrees, or about 5 degrees about the fulcrum to optimize a coupling of light from an optical waveguide attached to the optical ferrule to an intended optical component of the substrate. In some embodiments, the intended optical component is an optical grating coupler.

In some embodiments, the fulcrum includes two segments separated by a space. In such embodiments, the space is such that the two segments are configured to be disposed on opposing sides of the optical component such that the fulcrum straddles the optical component when mounted on the substrate.

According to some aspects of the present description, an optical cradle may be configured to mount on a substrate and to receive and secure an optical ferrule. In some embodiments, when the optical cradle is permanently mounted on the substrate and light from the optical ferrule is optimally transmitted to an optical component of the substrate, the optical cradle may make physical contact with the substrate only along one or more substantially colinear lines of contact. In some embodiments, the optical cradle may include a bottom surface having the one or more substantially colinear lines of contact disposed between, and away from, opposing front and rear edge lines of the optical cradle. In some embodiments, the bottom surface may include a fulcrum feature, where the fulcrum feature defines the one or more substantially colinear lines of contact.

According to some aspects of the present description, a method of aligning an optical cradle to an optical component includes the steps of:
inserting an optical ferrule in the optical cradle, the optical cradle including a pocket for receiving and securing the optical ferrule, and the optical cradle including at least one fulcrum configured to make contact with the substrate,
bringing the fulcrum into contact with the substrate, while coupling light between the optical ferrule and the optical component,
aligning the cradle with the optical component,
applying an adhesive to the optical cradle and the substrate, and
curing the adhesive.

In some embodiments, the step of aligning the cradle with the optical component may include the steps of measuring a strength of the light coupled between the optical ferrule and the optical component and rotating the optical cradle about the fulcrum to angularly align the optical cradle to the optical component based on the strength of the coupled light. In some embodiments, the step of aligning the cradle with the optical component further includes maximizing a strength of the coupled light.

In some embodiments, the optical ferrule may be removed from the optical cradle prior to applying the adhesive. In some embodiments, the method may further include the steps of applying an optical material to the substrate prior to bringing the fulcrum into contact with the substrate. In such embodiments, the optical material may be substantially index-matched to a material of the optical cradle and may include/encompass an optical path between the optical cradle and the substrate. In some embodiments, the optical material may be an optical gel. In other embodiments, the optical material may be an optical adhesive. In such embodiments, the optical adhesive may be cured by actinic radiation (e.g., cured by the application of light).

In some embodiments, the step of curing the adhesive may include thermal curing (i.e., an application to heat to initiate curing of the adhesive). In some embodiments, the adhesive may be configured to withstand a temperature associated with a solder reflow process.

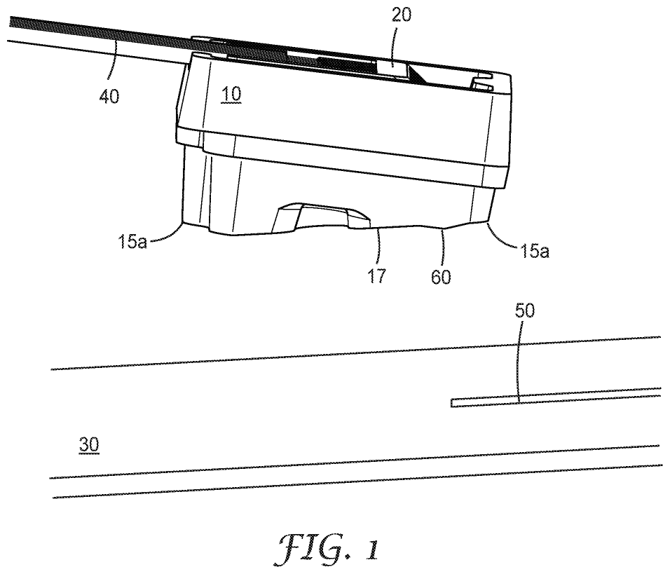

Turning now to the figures, FIG. 1 is a perspective view of an optical cradle with a fulcrum feature, according to the present description. In some embodiments, an optical cradle 10 is configured to mate with an optical ferrule 20 and to permanently bond to a substrate 30. In some embodiments, optical cradle may be configured such that light from an optical waveguide 40 (e.g., one or more optical fibers) coupled to the optical ferrule 20 exits the optical ferrule 20 and couples to an optical component 50 on substrate 30. (See additional detail on the optical path of the light and other features in other figures included elsewhere herein). It should be noted that light may pass in either direction along the optical path, such that light may be transmitted from the optical component 50 to the optical ferrule 20, or from optical ferrule 20 to the optical component 50, or in both directions. The examples provided herein are not intended to be limiting and generally cover the coupling of light between optical ferrule 20 and optical component 50, regardless of the direction of light transmission.

In some embodiments, optical cradle 10 may have at least one fulcrum 60 located on a bottom surface 17 of optical cradle 10 (i.e., the surface of optical cradle 10 facing substrate 30). In some embodiments, fulcrum 60 is configured to make contact with substrate 30 and to allow a rotation of the optical cradle 10 about the contact in order to angularly align optical cradle 10 to optical component 50. In some embodiments, optical component 50 may be an optical grating coupler of a photonics integrated circuit (PIC).

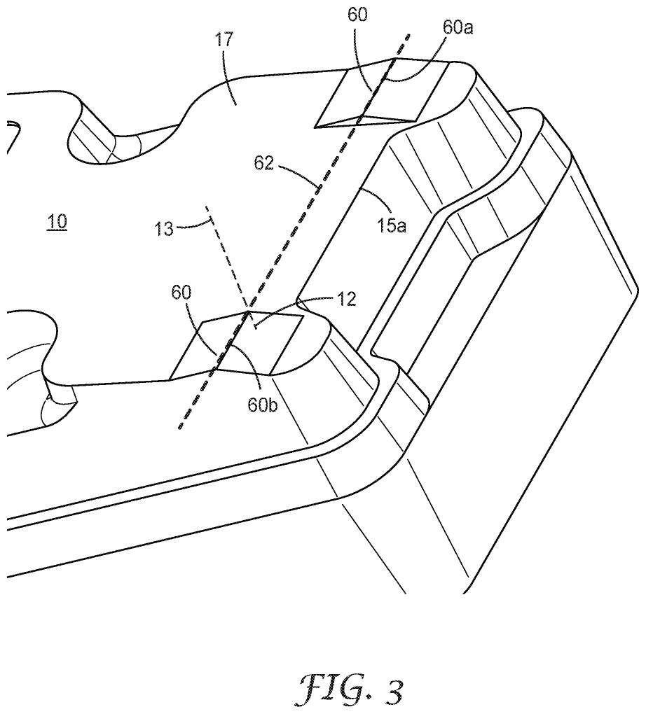

In some embodiments, the at least one fulcrum 60 may define one or more substantially colinear lines of contact 60a/60b (see FIG. 3) disposed between, and away from, a front edge line 15a and an opposing rear edge line 15b of optical cradle 10.

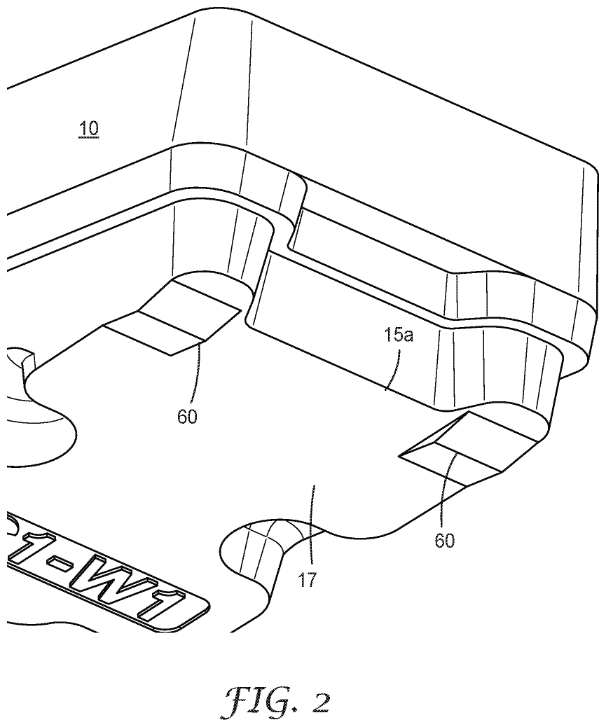

FIG. 2 is an alternate perspective view of optical cradle 10 of FIG. 1, showing additional detail of an embodiment of fulcrum 60. In particular, FIG. 2 is a view showing optical cradle 10 from below to highlight bottom surface 17. Bottom surface 17 of optical cradle 10 may include a fulcrum feature 60 with one or more segments or “pivot portions” (e.g., the two portions marked as 60 in FIG. 2). The fulcrum feature 60 may be disposed away from front edge 15a of cradle 10.

FIG. 3 is an additional alternate perspective view of optical cradle 10 of FIGS. 1 and 2 with additional details regarding fulcrum feature 60. Again, FIG. 3 shows a view of cradle 10 highlighting bottom surface 17 and one or more pivot portions (fulcrum) 60. The one or more pivot portions 60 of the fulcrum feature define an axis of rotation 62 of the optical cradle 10. When the one or more pivot portions 60 of optical cradle 10 make physical contact with a substrate (such as substrate 30 of FIG. 1), the contact is made with substrate 30 only along one or more substantially colinear lines of contact 60a, 60b.

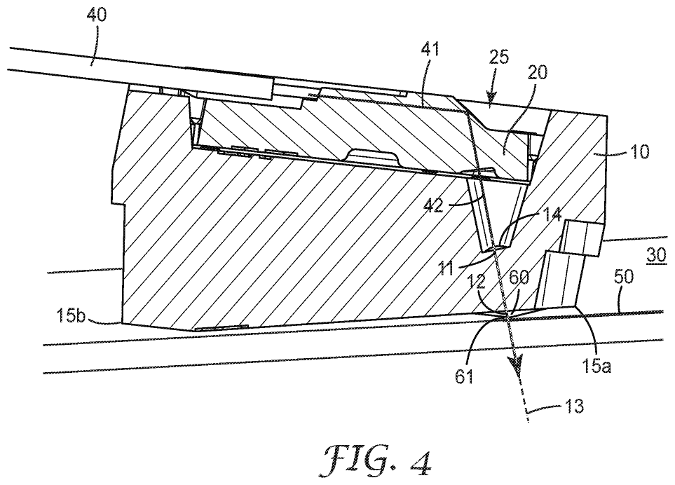

In some embodiments, optical cradle 10 is configured to removably receive and secure an optical ferrule (such as optical ferrule 20 of FIG. 1) so that a light ray (i.e., a central light ray of the light beam) exiting the optical ferrule 20 enters the optical cradle 10 at a first location of the optical cradle (e.g., a first location proximate to the optical ferrule, see element 11 of FIG. 4) and exits the optical cradle at second location 12 on the bottom surface 17 of optical cradle 10. In some embodiments, first location 11 and second location 12 define an optical axis 13 passing therethrough. In some embodiments, optical axis 13 passes within about 500 microns, or about 450 microns, or about 400 microns, or about 350 microns, or about 300 microns, or about 250 microns, or about 200 microns, or about 150 microns, or about 100 microns, or about 50 microns, or about 25 microns, or about 10 microns, or about 5 microns of axis of rotation 62.

FIG. 4 is a cutaway view of an optical connection between an optical ferrule 20 and an optical cradle 10, according to aspects of the present description. In some embodiments, optical cradle 10 includes a pocket 25 for receiving and securing an optical ferrule 20. In some embodiments, one or more optical waveguides 40 (e.g., optical fibers) are coupled to optical ferrule 20. In some embodiments, a light ray 42 (e.g., a central light ray) from optical waveguides 40 may be directed through (e.g., be redirected or refocused by) optical ferrule 20 and exit optical ferrule 20. After exiting optical ferrule 20, light ray 42 may enter optical cradle 10 and first location 11 and exit optical cradle 10 at a second location 12. Exiting light ray 42 may follow an optical axis 13 defined by first location 11 and second location 12. In some embodiments, optical cradle 10 may further include an optical lens 14, disposed at at least one of the first location 11 and second location 12 and configured to change at least a divergence of the light ray 42 passing therethrough (e.g., focus light ray 42 on a target location). In some embodiments, optical cradle 10 includes one or more pivot portions 60 (defining one or more fulcrums) which make contact 61 with substrate 30 and which define an axis of rotation 62 (see axis of rotation 62. FIG. 3). In some embodiments, optical axis 13 passes within about 500 microns, or about 450 microns, or about 400 microns, or about 350 microns, or about 300 microns, or about 250 microns, or about 200 microns, or about 150 microns, or about 100 microns, or about 50 microns, or about 25 microns, or about 10 microns, or about 5 microns of axis of rotation 62 (i.e., the axis of rotation defined by point of contact 61 with substrate 30).

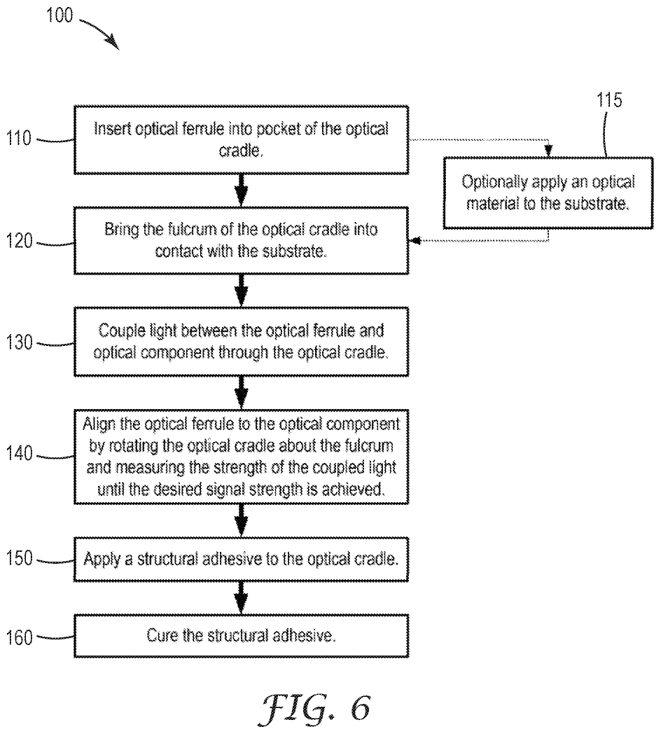

In some embodiments, optical cradle 10 may be rotated about pivot portions/fulcrum 60 to angularly align optical ferrule 20 to an optical component 50 (e.g., an optical grating coupler) on substrate 30. Pivot portions/fulcrum 60 and the one or more substantially colinear lines of contact (see elements 60a, 60b, FIG. 3) may be disposed between, and away from, front edge line 15a and opposing rear edge line 15b of optical cradle 10. In some embodiments, optical cradle 10 may be aligned with optical component 50 by coupling light (e.g., light ray 42) between the optical ferrule 20 and optical component 50 and rotating optical cradle 10 about pivot portions/fulcrum 60 until an optical light signal is coupled between optical ferrule 20 and optical component 50 (e.g., a light signal of maximum strength). Once optical angular alignment between optical ferrule 20 and optical component 50 is achieved, an adhesive (e.g., a structural, thermal adhesive) may be applied between substrate 30 and optical cradle 10 to hold it at the desired angle. Additional detail on the alignment process is provided in FIG. 6 and the corresponding description.

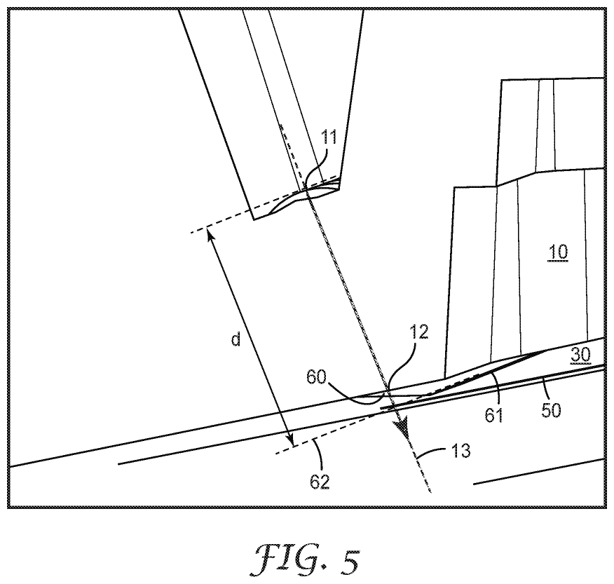

FIG. 5 is a cutaway view of optical cradle 10 with a fulcrum feature 60, showing additional details of the optical path. In some embodiments, optical cradle 10 may be configured to mate with an optical ferrule 20 (see optical ferrule 20. FIG. 4) and be permanently bonded to a substrate 30. Light (such as light ray 42. FIG. 4) exits optical ferrule 20, enters optical cradle 10 and first location 11 of optical cradle 10 and exits optical cradle 10 at second location 12, defining optical axis 13 and a distance, d, between first location 11 and optical component 50. In some embodiments, optical cradle 10 includes a fulcrum 60 which is configured to make contact 61 with substrate 30 and allow rotation of optical cradle 10 about an axis of rotation 62 defined by line of contact 61. In some embodiments, fulcrum 60 may be configured to allow a rotation of optical cradle 10 about axis of rotation 62 to angularly align the optical cradle 10 to the optical component 50 without substantially changing the distance, d, between first location 11 and the optical component 50. In some embodiments, the distance d is approximately the focal length of any lens (e.g., optical lens 14 of FIG. 4) proximate location 11.

Finally, FIG. 6 is a flowchart detailing the steps in a method of optically aligning an optical cradle to an optical component on a substrate, according to the present description. In some embodiments, Method 100 includes the following steps:

Step 110: An optical ferrule (such as optical ferrule 20, FIG. 4) is inserted into an optical cradle (such as optical cradle 10, FIG. 4). The optical cradle 10 may include a pocket for receiving and securing optical ferrule 20, and optical cradle 10 may further include at least one fulcrum (such as fulcrum 60, FIG. 4) configured to make contact with the substrate. In some embodiments, the purpose of the fulcrum is to allow a rotation of the optical cradle to optimize the light coupling between the optical ferrule and the optical component on the substrate.

Optional Step 115: In some embodiments, an optical material (e.g., an optical gel, or an optical adhesive) may be applied to the substrate prior to aligning the cradle with the optical component, such that the optical material includes or encompasses the optical path between the optical cradle and optical component on the substrate. In some embodiments, such as when the optical material is an optical adhesive, the optical material may be cured once an alignment of the cradle and the optical component is optimized. In some embodiments, the optical material may be substantially index-matched to the material of the optical cradle. In such embodiments, the optical adhesive may be cured by actinic radiation (e.g., light cured).

Step 120: The fulcrum of the optical cradle is brought into contact with the substrate, creating an axis of rotation along the points of contact between the fulcrum and the substrate. Compliant fixtures may be used to position the cradle while holding the fulcrum in contact with the substrate during subsequent steps.

Step 130: Couple light between the optical ferrule and the optical component through the optical cradle.

Step 140: Align the optical ferrule with the optical component. In some embodiments, this alignment includes repositioning the optical cradle and rotating the optical cradle about the fulcrum while measuring the strength of light coupled between the optical ferrule and the optical component until the strength of the coupled light is optimal. In some embodiments, optimal optical alignment is defined as the angle of alignment at which the light coupled between the optical ferrule and the optical component is at maximum strength.

In some embodiments of Method 100, the optical ferrule may be removed from the optical cradle prior to applying the adhesive (and after optical alignment is achieved).

Step 150: Apply an adhesive to the optical cradle once optical alignment is achieved in Step 140.

Step 160: Cure the adhesive. In some embodiments, curing the adhesive may be a thermal curing (e.g., an application of heat) of the adhesive. In such embodiments, the cured adhesive may be configured to withstand the temperature associated with a solder reflow process.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description. “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical cradle configured to mate with an optical ferrule and permanently bond to a substrate so that light may be coupled between an optical waveguide coupled to the optical ferrule and an optical component on the substrate through at least a first location of the optical cradle, the optical cradle comprising at least one fulcrum extending from a bottom surface of the optical cradle and configured to make contact with the substrate and allow a rotation of the optical cradle about the contact to angularly align the optical cradle to the optical component without substantially changing a distance between the first location and the optical component.

2. The optical cradle of claim 1, further comprising an optical lens disposed proximate the first location.

3. The optical cradle of claim 2, wherein the distance between the first location and the optical component is approximately a focal length of the optical lens.

4. The optical cradle of claim 1, wherein the optical component is an optical grating coupler.

5. The optical cradle of claim 1, wherein the at least one fulcrum comprises at least two segments separated by a space.

6. The optical cradle of claim 5, wherein the space is such that the at least two segments are disposed on opposing sides of the optical component and the at least one fulcrum does not directly contact the optical component.

7. An optical cradle configured to removably receive and secure an optical ferrule so that a central light ray exiting the optical ferrule enters the optical cradle at a first location of the optical cradle and exits the optical cradle at a second location of the optical cradle, the first and second locations defining an optical axis passing therethrough, the optical cradle comprising one or more pivot portions defining an axis of rotation of the optical cradle, such that the optical axis passes within about 500 microns of the axis of rotation.

8. The optical cradle of claim 7, further comprising an optical lens at at least one of the first and second locations, the optical lens configured to change at least a divergence of light passing therethrough.

9. The optical cradle of claim 8, wherein the optical component is within about 50 microns of a focal point of the optical lens.

10. The optical cradle of claim 7, wherein the one or more pivot portions are disposed such that they do not comprise the second location of the optical cradle.

11. The optical cradle of claim 7, wherein the one or more pivot portions comprise two pivot portions spaced apart and disposed on opposing sides of the second location of the optical cradle.

12. An optical cradle configured to mount on a substrate and receive and secure an optical ferrule so that a light ray is coupled between the optical ferrule and an optical component of the substrate, the optical cradle comprising one or more pivot portions extending from a bottom surface of the optical cradle and defining, in combination, an axis of rotation of the optical cradle, such that when the optical cradle rests on the substrate, the one or more pivot portions allow the optical cradle to rotate about the axis of rotation to adjust a tilt of the optical cradle relative to the substrate.

13. The optical cradle of claim 12, wherein the one or more pivot portions are configured such that the tilt of the optical cradle relative to the substrate may be adjusted by up to 5 degrees.

14. The optical cradle of claim 12, wherein rotating the optical cradle about the axis of rotation changes an angle of an optical path of the light ray between the optical ferrule and the optical component.

15. The optical cradle of claim 12, wherein the optical component is an optical grating coupler.
